(19) United States
(12) Patent Application Publication
(10) Pub. No.: US 2008/0070004 A1
(43) Pub. Date: Mar. 20, 2008

(54) Apparatus having a friction surface with a coating containing silicone

(75) Inventor: Christian Wickel, Wartmannsroth (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/899,484

(22) Filed: Sep. 6, 2007

(30) Foreign Application Priority Data
Sep. 7, 2006 (DE) 10 2006 042 483.2
Aug. 10, 2007 (DE) 10 2007 037 682.2

(51) Int. Cl. B32B 3/00; B05D 1/28; B05D 3/02; B05D 3/10; B05D 5/00

(52) U.S. Cl. 428/141; 427/256; 427/301; 427/397.7; 427/428.01

(57) ABSTRACT

In an apparatus with at least two components which frictionally interact when used as intended to transmit a torque, especially a friction clutch or a brake, the frictionally exposed surface of at least one of the components is provided with a coating. To prevent variations in the coefficient of friction caused by run-in, the coating consists of silicone or contains silicone. According to a preferred method for producing an apparatus of this type, only a portion of the frictionally exposed surface is coated.

### BACKGROUND OF THE INVENTION

1. Field of the Invention

The invention pertains to an apparatus in which at least two components frictionally interact when used as intended to transmit a torque, especially a friction clutch or a brake, where, to prevent variations in the coefficient of friction caused by run-in, the frictionally-exposed surface of at least one of the components is provided with a coating. The invention also pertains to a method for producing a device of this type.

2. Description of the Related Art

It is known that the coefficient of friction of a friction pairing depends on the state of the friction partners. In particular, the coefficient of friction in a friction pairing such as that in a friction clutch changes as a function of the duration of its use, i.e., the number of load-change cycles. FIG. 2 shows schematically the relationship between the coefficient of friction p and the number of load cycle operations N in a friction clutch. When the clutch is new, that is, especially when the friction linings are new, the coefficient of friction is still relatively low. It increases gradually with the number of load cycles until it remains at a more-or-less constant level.

In the case of new friction linings, therefore, the initial coefficient of friction is sometimes much lower than it is after the linings have been run in. The design of the device, especially the design of a friction clutch, however, is usually based on the run-in state, that is, on the state in which the coefficient of friction has reached its high, permanent value. It is disadvantageous, therefore, that it is necessary to base the clutch design on a higher safety factor, so that satisfactory clutch behavior is guaranteed even after the friction linings have been run in. It is also known that, to solve this problem, a shielding of the pressure plate can be provided to increase the friction radius.

It is known from DE 100 02 261 A1 that, to solve the previously mentioned problem, the friction lining to be used can be provided with a surface coating. An acrylate-based substrate is provided as the coating material. It is also proposed that one or more materials such as quartz, silica gel, silicate, oxide ceramic, or organic or inorganic polymers be added.

It has been found that, although these solutions do provide a certain improvement, disadvantages continue to be present. A problem which occurs with coated friction surfaces is that the coating can cause the friction partners which frictionally interact when used as intended to stick together, which negatively affects the operating behavior during the run-in phase of the device.

### SUMMARY OF THE INVENTION

An object of the invention is to provide an apparatus of the type indicated above and an associated method for its production which provide an improvement in regard to the aspects indicated above. The goal is not to abandon the advantages to be derived from coating the friction partners while at the same time eliminating the observed disadvantages of such coatings, especially the sticking-together of the interacting components.

According to the invention, the coating of the participating friction partners consists of silicone or contains silicone. The silicone is preferably a silicone elastomer or a silicone resin.

It is preferable to coat a friction surface of a friction lining of the apparatus, that is, especially the lining of a friction clutch or of a brake. Alternatively or in addition, it is also possible to coat a friction surface which opposes the friction lining, especially a pressure plate and/or a flywheel of the clutch device.

The coating can be applied over the entire frictionally exposed surface of the component. It is also possible to achieve good results when the coating is applied to only a portion of the frictionally exposed surface of the component.

The coefficient of friction can be effectively adjusted to a desired value by applying a coating over only part of the surface. In addition, it is possible in this way to exert an influence on the tendency to “grab”, that is, on the development of vibrations when the clutch is being engaged.

The method for producing an apparatus in which at least two components frictionally interact when being used as intended to transmit a torque, especially a friction clutch or a brake, where, to prevent variations in the coefficient of friction caused by run-in, the frictionally exposed surface of at least one of the components is provided with a coating, is characterized according to the invention in that, before the device is used as intended, a coating of silicone or a coating which contains silicone is applied to the surface of at least one of the components.

As previously mentioned, the coating can also be applied to only a portion of the frictionally exposed surface of the component. For this purpose, coatings applied by screen printing, coatings applied by pad printing, and coatings applied by a profiled applicator roll have been found to give especially good results. Thus it is possible to precisely define a certain partial area of the surface to be coated and then to apply the coating to that partial area by means of the methods indicated.

There are various methods which can be used to cure the coating after it has been applied. One solution consists in curing the coated component at room temperature after application of the coating. It is also possible to cure at a temperature higher than room temperature. There is also a preferred possibility of subjecting the component, after the application of the coating, to a UV light-curing process.

Another advantageous procedure for implementing the invention consists in applying to the surface of the minimum of one component at least two different coating components which enter into a chemical reaction with each other.

The viscosity of the layer to be applied can be adjusted and optimized by adding a solvent to the coating material before the coating is applied. For this purpose, an organic solvent or even water can be used, the latter possibility being characterized by especially good environmental compatibility.

Through the proposed realization of the inventive apparatus and of the method, the components of the apparatus which frictionally interact when used as intended have a higher initial coefficient of friction as a result of the applied coating.

The proposed coating materials in the form of a silicone are highly heat-resistant. In addition, the danger of the friction partners sticking together is virtually excluded.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a radial cross section through a clutch device of a motor vehicle; and

FIG. 2 shows how the coefficient of friction changes as the number of load cycles of a clutch device increases.

### DETAILED DESCRIPTION OF THE PRESENTLY PREFERRED EMBODIMENTS

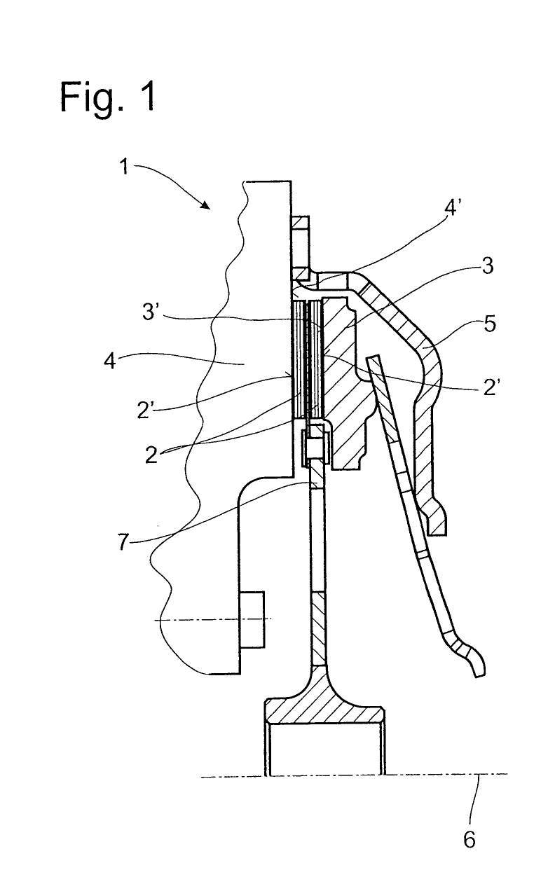

FIG. 1 shows a clutch device 1 of conventional design. A clutch housing 5 is connected nonrotatably to a flywheel 4 of an internal combustion engine, where the housing 5 and the flywheel 4 are able to rotate around an axis of rotation 6. In the housing 5, a pressure plate 3 is installed, which is supported nonrotatably with respect to the housing 5 but with freedom of movement in the axial direction. Between the pressure plate 3 and the flywheel 4 is a clutch disk 7, which carries a friction lining 2 on each side.

When the pressure plate 3 is pushed axially toward the flywheel 4, the frictional connection between the friction lining 2 and the flywheel 4 and between the friction lining 2 and the pressure plate 3 allows torque to be transmitted from the flywheel 4 to the clutch disk 7, which is connected nonrotatably to a gearbox input shaft (not shown).

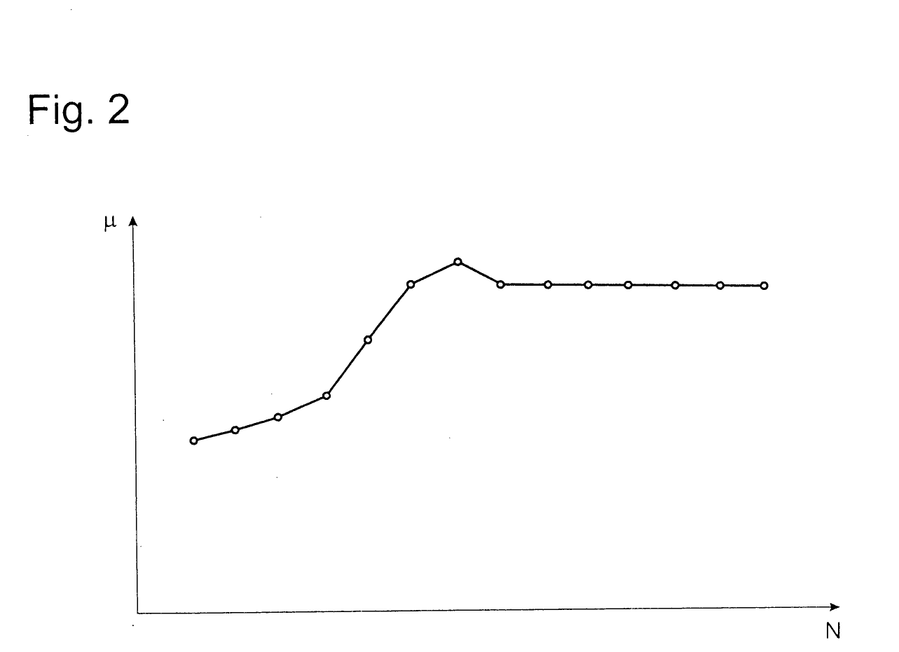

As can be seen in FIG. 2, the coefficient of friction p versus the number of load cycles N, that is, ultimately versus the useful life of the device, is rather highly variable. To minimize this effect, the surface of at least a portion of the participating friction partners is coated according to the invention. The following can be coated: one or both friction surfaces 2′ of the friction lining 2 and/or the friction surface 3′ of the pressure plate 3 and/or the friction surface 4′ of the flywheel 4.

According to the invention, the coating consists of silicone or contains silicone.

The term “silicone” covers a group of synthetic polymers, in which silicon atoms are linked via oxygen atoms to form molecular chains and/or crosslinked structures. The remaining free valence electrons of the silicone are saturated by hydrocarbon residues (usually methyl groups). On the basis of its typical inorganic structure on the one hand and its organic residues on the other, silicones occupy an intermediate position between inorganic and organic compounds, especially between the silicates and the organic polymers. They are therefore in a certain sense hybrids and have a special spectrum of properties which other plastics do not have.

Simple linear silicones have the structure (R₂SiO)ₙ, where R₂SiO corresponds to the general formula for ketones R₂C═O. Because Si—O double bonds are not stable, however, this derivation is to be understood as purely formal. Si—O—Si bonds, on which the silicones are based, are called “siloxane” bonds. Silicones are therefore polyorganosiloxanes.

The following remarks should be made concerning silicone elastomers: Examples of these types of materials are silicone caoutchouc and silicone rubber as elastic silicone elastomers. Silicone caoutchoucs are pastes which have been converted to the rubber-elastic state, which contain polydiorganosiloxanes as base polymers with groups accessible to crosslinking reactions.

The following remarks should be made concerning silicone resins: The silicone resins normally used are crosslinked polymethylsiloxanes or polymethylphenylsiloxanes, the elasticity and heat resistance of which increase with the phenyl group content. Pure methylsilicone resins are relatively brittle and moderately heat-resistant. The long-term heat resistance of silicone resins, however, is high. A methylphenylsilicone resin can withstand 10,000 hours at 200° C.

The friction surface is partially coated in the manner explained above, where in particular screen printing and pad printing are used. Screen printing is sufficiently well known. Pad printing is an indirect printing method based on the gravure principle. The printing plate carries the image to be printed recessed into its surface. The doctor blade floods the coating into the lower-lying print image and cleanly wipes off the excess coating paste. After the wiping, an elastic printing pad travels over the cliche and picks up the coating paste remaining behind with a lifting motion. This paste is then transferred to the part to be coated, which is therefore coated indirectly.

The coating of only part (not all) of the friction surface(s) is also to be understood here—regardless of what coating material is used—as an independent invention, especially in combination with the proposed preferred coating methods.

In this context it should also be remarked that good results have been obtained when only a fraction, i.e., between 15% and 85%, of the friction surface 2′, 3′, 4′ is coated rather than 100% of the surface. The surface to be coated is even more preferably in the range of 25-75% of the total surface.

Before the coating paste is applied, it should be pretreated to adjust its viscosity, so that optimal processing can be guaranteed. A suitable treatment consists in adding a solvent.

This can be an organic solvent, but such solvents are environmentally harmful. Nevertheless, processability can be improved in this way, and the viscosity can be adjusted through the choice of the solvent content. The solvent evaporates rapidly after application, which is advantageous.

It is also possible to use water as the solvent. This is environmentally friendly, but the silicone must usually be modified first to allow its use. Evaporation after application is also slower. There is also a sensitivity to frost.

The compound can also be applied without any solvent at all. The silicones are in some cases liquid in the uncrosslinked state and are suitable for direct application. The viscosity is a function of the silicones being used, and frequently the material has a pasty consistency. The ability to adjust the viscosity in these cases, however, is limited.

After the coating has been applied, the layer is cured.

“Room-curing” the silicone (curing the silicone at room temperature) is advantageous because no special equipment is required. Nevertheless, relatively long drying times (up to 40 minutes) are typical, depending on the humidity.

In the case of a multi-component silicone coating, several components are mixed together, and the silicone cures as a result of a chemical reaction.

In the case of UV curing, the applied coating is exposed to UV light. Curing can proceed very quickly (less than 20 seconds in some cases), which makes it possible to produce the devices on an assembly line.

In the case of “temperature curing”, the silicone cures as a result of temperature activation (above room temperature). Appropriate equipment is required for such processes.

The invention is not limited by the embodiments described above which are presented as examples only but can be modified in various ways within the scope of protection defined by the appended patent claims.

What is claimed:

1. Apparatus comprising at least two components which can be frictionally engaged to transmit torque, at least one of said components having a frictionally exposed surface which is provided with a coating, wherein said coating contains silicone.

2. The apparatus of claim 1 wherein the coating consists of silicone.

3. The apparatus of claim 1 wherein the silicone is a silicone elastomer.

4. The apparatus of claim 1 wherein one of said components comprises a friction lining, said friction lining having a friction surface which is provided with said coating.

5. The apparatus of claim 1 wherein one of said components is a flywheel, said flywheel having a friction surface which is provided with said coating.

6. The apparatus of claim 1 wherein one of said components is a pressure plate, said pressure plate having a friction surface which is provided with said coating.

7. The apparatus of claim 1 wherein the frictionally exposed surface is provided with said coating in entirety.

8. The apparatus of claim 1 wherein only a portion of the frictionally exposed surface is provided with said coating.

9. A method of producing an apparatus having at least two components which can be frictionally engaged to transmit torque, at least one of said components having a frictionally exposed surface, wherein a coating containing silicone is applied to said frictionally exposed surface.

10. The method of claim 9 wherein the coating consists of silicone.

11. The method of claim 9 wherein the coating is applied to only a portion of the frictionally exposed surface.

12. The method of claim 9 wherein the coating is applied by screen printing.

13. The method of claim 9 wherein the coating is applied by pad printing.

14. The method of claim 9 wherein the coating is applied by means of an applicator roll.

15. The method of claim 9 wherein the coating is cured at room temperature or higher after application.

16. The method of claim 9 wherein the coating is cured with UV light after application.

17. The method of claim 9 wherein the coating is applied as at least two coating components which react chemically to form said coating.

18. The method of claim 9 wherein the coating is applied as a coating material containing a solvent which evaporates after application.

19. The method of claim 19 wherein the solvent is one of an organic solvent and water.
